(19) United States
(12) Patent Application Publication
(10) Pub. No.: US 2010/0181513 A1
(43) Pub. Date: Jul. 22, 2010

(54) METHOD AND ELECTRONIC DEVICE FOR FINDING THE OPENING POINT FOR A REGULATED ELECTROPNEUMATIC VALVE OF A PNEUMATIC ACTUATING DRIVE

(75) Inventor: Heiko KRESSE, Obernkirchen (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/687,679

(22) Filed: Jan. 14, 2010

(30) Foreign Application Priority Data
Jan. 14, 2009 (DE) 10 2009 004 570.8

(51) Int. Cl. F16K 31/02

(52) U.S. Cl. 251/129.04

(57) ABSTRACT

A method and an electronic device are disclosed, for finding an opening point for an electropneumatic valve, which method or electronic device can be used in a closed control loop for position regulation of a switching element of a pneumatic actuating drive for a fitting which can be operated thereby. An exemplary method can include: a) energizing the electropneumatic valve by a drive signal which corresponds to an estimated opening point; b) measuring control-loop characteristics for this drive signal by using sensors to detect movement of the switching element; c) if determined control-loop characteristics for a present opening point do not correspond to nominal presets, then varying the drive signal based on an evaluation result to produce a better-matched opening point, and the finding process then starts again with step a).

### RELATED APPLICATION

This application claims priority under 35 U.S.C. §119 to German Patent Application No. 10 2009 004 570.8 filed in Germany on Jan. 14, 2009, the entire content of which is hereby incorporated by reference in its entirety.

### FIELD

The present disclosure relates to a method for finding the opening point for an electropneumatic valve, such as a valve used in a closed control loop for position regulation of a switching element of a pneumatic actuating drive for a fitting which can be operated thereby.

### BACKGROUND INFORMATION

Pneumatic actuating drives can have a position regulator which regulates a desired opening level of a fitting, which is connected to the pneumatic actuating drive, on the basis of a predetermined nominal value. By way of example, the fitting may be a process valve within a pipeline system of a process installation. In addition, a pneumatic actuating drive can be used for operation of other industrial fittings and the like.

The product prospectus “Der kompakte, intelligente Stellungsregler” [The compact, intelligent position regulator] (ABB Automation Products GmbH, document number: 50/18-19 DE RevA, June 2005 edition) discloses an electronic position regulator for a pneumatic actuating drive. The position regulator can be formed as a type of electronics box which can be fitted to the pneumatic actuating drive. The position regulator can be a configurable appliance which can communicate, for example, via a field bus. An exemplary functional aspect is a microprocessor-controlled procedure for a regulation program with a sampling rate of 20 ms. The nominal value can in this case be preset via a fieldbus connection which is designed using two-conductor technology. Furthermore, the position regulator can have a supply air connection for an air pressure up to a maximum of 6 bar, as well as a working connection for passing on the control pressure generated by the position regulator to the control chamber of the pneumatic position regulator.

A sensor input can be provided for the actual value of the present position of the switching element which is operated by the pneumatic actuating drive, which position can be obtained via a position sensor arranged on the switching element. The pneumatic drive for the actuating drive can be provided continuously by an I/P module with a downstream 3/3-way valve. The 3/3-way valve can control the passage for ventilation or venting of the actuating drive as proportionally as desired. A closed position, in which all the external connections are blocked, is assumed in a mid-position. The configuration and observation of the operating state of the position regulator can be carried out either by a built-in control panel directly in situ, or centrally via a communication connection, on the basis of the bus protocol via a superordinate control unit.

US 2007/0045579 A1 discloses a pneumatic position regulator formed as an I/P module with a 3/3-way valve. The 3/3 switching function allows switch positions of ventilation, a closed position and venting of a working connection, which supplies the control pressure for the connected pneumatic actuating drive. The electropneumatic valve with a 3/3 switching function can have two closure elements, which point in mutually opposite directions of the actuating movement and act with the same magnitude with respect to one another, each of which bounds an internal control chamber, with a common control pressure connection being associated with the two control chambers. While one closure element is used for ventilation of the working connection, the other closure element is used for venting of the working connection. When neither of the two closure elements is operated, then the valve is in the closed position.

For position regulation, an electropneumatic valve such as this can be intended to provide as proportional a response as possible for the electrical drive signal with respect to the pneumatic manipulated variable of the switching element that is supplied, with disturbance variables, which are caused by the forces on the switching element of the fitting and the hysteresis, reacting on the pneumatic side. Influencing variables such as temperature fluctuations, pressure fluctuations and the like can disturb an ideal proportionality ratio. In order nevertheless to achieve a response which is, for example, as linear as possible, the position regulator in some cases can take account of correction values determined using sensors. The results which can be achieved in this way may, however, not be satisfactory. Another influencing factor is the hysteresis of the valve mechanism. All of these influencing factors can make it harder to find an ideal opening point of the electropneumatic valve, which is desired to achieve good regulation accuracy.

The desired opening point can be found during the initialization of the position regulator, with the assistance of a position sensor system which finds the position of the switching element at the start of a ventilation or venting process. Position regulators are in this way measured after fabrication by the manufacturer.

Furthermore, it is also known for the measurement process to be carried out directly by evaluation of the speed profile over the travel movement of the switching element. Here, the control-loop characteristic is ignored. Particularly in the case of small-volume pneumatic actuating drives, there is a risk of striking an end stop on the travel movement, which can result in damage to the appliance.

### SUMMARY

A method for finding an opening point is disclosed for an electropneumatic valve, which is used in a closed control loop for position regulation of a switching element of a pneumatic actuating drive, the method comprising: a) energizing the electropneumatic valve by a drive signal which corresponds to an estimated opening point; b) measuring control-loop characteristics for the drive signal by using sensors to detect movement of the switching element; and c) varying the drive signal when the control-loop characteristics for a present opening point do not correspond to a nominal preset to produce a better-matched opening point, and then repeating step a).

An electronic device for finding an opening point is also disclosed for an electropneumatic valve of a position regulator for a switching element of a pneumatic actuating drive, comprising: a sensor for measuring control-loop characteristics for a drive signal to detect movement of a switching element; and a regulation unit for energizing an electropneumatic valve by the drive signal which corresponds to an estimated opening point, and for varying the drive signal when the control-loop characteristics for a present opening point do not correspond to a nominal preset.

A computer readable medium is also disclosed for causing a computer to execute steps of: a) energizing an electropneumatic valve by a drive signal which corresponds to an estimated opening point; b) measuring control-loop characteristics for the drive signal by using sensors to detect movement of a switching element of a pneumatic actuating drive; and c) varying the drive signal when the control-loop characteristics for a present opening point do not correspond to a nominal preset to produce a better-matched opening point, and then repeating step a).

### BRIEF DESCRIPTION OF THE DRAWINGS

Other features and advantages will be described in more detail in the following text, together with the description of exemplary preferred embodiments, with reference to the Figures, wherein:

FIG. 1 shows a schematic side view of an exemplary pneumatic actuating drive for a fitting; and

FIG. 2 shows a flowchart of an exemplary routine for finding an opening point of an electropneumatic valve for the pneumatic actuating drive shown in FIG. 1.

### DETAILED DESCRIPTION

An exemplary method and an electronic device are disclosed for finding an opening point, by which an appliance can be initialized during the course of commissioning in a simple manner, in order to ensure a high regulation quality.

In an exemplary method, an electropneumatic valve of a pneumatic actuating drive can be energized by a drive signal which corresponds to an estimated opening point. The control-loop characteristics for this drive signal can then be measured by using sensors to detect movement of the switching element. If this leads to the result that the determined control-loop characteristics for the present opening point do not correspond to a defined nominal value preset, then the drive signal can be varied on the basis of the evaluated result, in order to produce a better-matched opening point. The finding process can then start again with the first method step. This method loop can be repeated until a determined control-loop characteristic(s) for the present opening point corresponds to the nominal preset(s).

According to exemplary embodiments, an ideal opening point to achieve high regulation accuracy can be found in a simple manner during a commissioning of an appliance, by carrying out the method loop as explained above automatically. There is therefore no need for complex matching of measured values determined separately by sensors. In addition, this can avoid the need for an additional sensor system associated therewith. Exemplary embodiments are suitable for small-value pneumatic actuating drives to, for example, preclude risk of damage.

In an exemplary embodiment, the drive parameters for energizing the electropneumatic valve can be preset separately for ventilation and venting. This can provide a capability to separately optimize upper and lower characteristic curve in order to allow an ideal opening point for ventilation and venting to be found separately.

The measurement of the control-loop characteristics can be carried out in various ways. For example, if the hysteresis is dominated essentially by sliding friction, the average speed which occurs between the switching element's breaking loose and stopping again can be used. If, on the other hand, the hysteresis is dominated by static friction, then the time between the switching element breaking loose and the start of the energizing process can be used to measure the control-loop characteristics, that is to say the time interval. If the switching element in this case moves too slowly then, as a consequence of this, an offset can be added to the drive signal which is sufficiently large to ensure that the switching element moves more quickly. This can make it possible to ensure that the drive signal approaches the optimum in steps, in order to find the ideal opening point.

However, as an exemplary alternative, it is also possible for the evaluation of the control-loop characteristics for the present drive signal to be carried out using a zero-point search method according to Newton, or a similar method which is based on a binary search, in order to find the ideal opening point quickly.

An exemplary method as disclosed herein can be implemented as a computer program product as a routine for determining the regulation characteristic, which product is composed of appropriate control commands which are stored in software, and is carried out by an electronic regulation unit. To this extent, the electronic regulation unit can include at least one microprocessor with a memory unit for storing the software and at least the parameters which influence the process. The electronic regulation unit, which is a component of the closed control loop in the pneumatic actuating drive, can be fitted into an electronic device as a position regulator, for example, directly to the pneumatic drive for operation of a fitting which is coupled thereto.

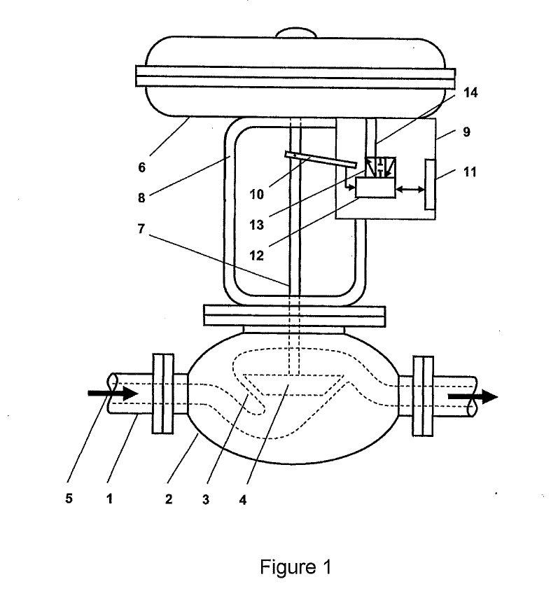

As shown in the exemplary embodiment of FIG. 1, a fitting 2 formed as a process valve with a seat structure is installed in a pipeline 1 of a process installation. In its interior, the fitting 2 has a closing body, which interacts with a valve seat 3, in order to control the amount of process medium 5 passing through. The closing body 4 can, for example, be operated linearly, as a pushrod, by a pneumatic actuating drive 6 via a switching element 7. The pneumatic actuating drive 6 can be firmly connected to the fitting 2 via a yoke 8. A position regulator 9 formed as an electronics module can also be fitted to the yoke 8.

The travel of the switching element 7 can be signaled to the position regulator 9 by means of a position sensor 10. The detected travel can be compared for normal operation with a nominal value which is, for example, supplied from the exterior and is stored in a memory unit, by means of a regulation unit 12, and the actuating drive 6 is driven as a function of the determined control error. The regulation unit 12 of the position regulator 9 has an electropneumatic valve 13 as an I/P converter for conversion of an electrical control error to an adequate control pressure. The electropneumatic valve 13 of the regulation unit 12 can be connected to the actuating drive 6 via a pressure medium supply 14. An internal switching membrane, which cannot be seen in any more detail here, but which operates the switching element 7, within the actuating drive 6 can be acted on by the control pressure which is supplied via the pressure medium supply 19.

In order to initialize the pneumatic actuating drive 6, the regulation unit 12 carries out a routine for finding the ideal opening point. The position regulator 9 can thus be automatically matched to the pneumatic actuating drive 6 which is operated by it, and to the fitting 2 which is in turn operated thereby. In order to find the opening point, the regulation unit 12 energizes the electropneumatic valve 13 with a drive signal which corresponds to an estimated opening point. The control-loop characteristics can be measured by using sensors to detect the movement of the switching element 7 which is initiated by this. A measurement result, which is represented as a measurement curve along the time ray, can be evaluated in order to vary the drive signal if the determined control-loop characteristics for the present opening point do not correspond to the nominal value presets.

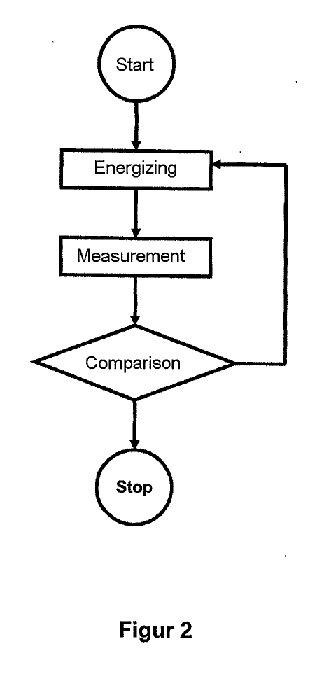

FIG. 2 illustrates exemplary method steps for finding the opening point, in the following sequence:
a) energizing by a drive signal which corresponds to an estimated opening point;
b) measuring the control-loop characteristics for this drive signal by using sensors to detect the switching element movement;
c) comparing with nominal presets for desired control-loop characteristics and jumping back to step a) if these do not correspond to the nominal preset(s), with the drive signal being varied in the direction of better control-loop characteristics in a next run through the loop.

Exemplary embodiments as disclosed herein can make it possible to find an opening point which is matched to the desired control-loop characteristics, in a simple manner during initialization of the appliance, independently of a pneumatic actuating drive that is used.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### List of Reference Symbols

1 Pipeline
2 Fitting
3 Valve seat
4 Closing body
5 Process medium
6 Pneumatic actuating drive
7 Switching element
8 Yoke
9 Position regulator
10 Position sensor
11 Memory unit
12 Regulation unit
13 Valve
14 Pressure medium supply

What is claimed is:

1. A method for finding an opening point for an electropneumatic valve, which is used in a closed control loop for position regulation of a switching element of a pneumatic actuating drive, the method comprising:
a) energizing the electropneumatic valve by a drive signal which corresponds to an estimated opening point;
b) measuring control-loop characteristics for the drive signal by using sensors to detect movement of the switching element; and
c) varying the drive signal when the control-loop characteristics for a present opening point do not correspond to a nominal preset to produce a better-matched opening point, and then representing step a).

2. The method as claimed in claim 1, comprising:
separately presetting, the drive parameters for energizing the electropneumatic valve are preset separately for ventilation and venting of the valve.

3. The method as claimed in claim 1, comprising:
measuring the control loop characteristics using an average speed which results between the switching element breaking loose and stopping again when hysteresis is dominated by sliding friction.

4. The method as claimed in claim 1, comprising:
measuring the control-loop characteristics using a time between the switching element breaking loose and a start of the energizing when hysteresis is dominated by static friction.

5. The method as claimed in claim 1, comprising:
applying a definable fixed offset to the drive signal for step-by-step variation of the drive signal when an unsatisfactory evaluation result occurs.

6. The method as claimed in claim 1, comprising:
evaluating the control-loop characteristics for a present drive signal using a zero-point search method.

7. An electronic device for finding an opening point for an electropneumatic valve of a position regulator for a switching element of a pneumatic actuating drive, comprising:
a sensor for measuring control-loop characteristics for a drive signal to detect movement of a switching element; and
a regulation unit for energizing an electropneumatic valve by the drive signal which corresponds to an estimated opening point, and for varying the drive signal when the control-loop characteristics for a present opening point do not correspond to a nominal preset.

8. The device as claimed in claim 7, comprising:
a electropneumatic valve having a 3/3 switching function, with switch positions of ventilation, a closed position and venting.

9. A computer readable medium for causing a computer to execute steps of:
a) energizing an the electropneumatic valve by a drive signal which corresponds to an estimated opening point;
b) measuring control-loop characteristics for the drive signal by using sensors to detect movement of a switching element of a pneumatic actuating drive; and
c) varying the drive signal when the control-loop characteristics for a present opening point do not correspond to a nominal preset to produce a better-matched opening point, and then repeating step a).

10. A computer readable medium claimed in claim 9, comprising:
a routine for finding the opening point by appropriate control commands which are stored in software.
